(19) United States
(12) Patent Application Publication
(10) Pub. No.: US 2025/0300403 A1
(43) Pub. Date: Sep. 25, 2025

(54) Shielding Component and Connector

(71) Applicants: Tyco Electronics Technology (SIP) Co., Ltd., Suzhou (CN); Tyco Electronics (Shanghai) Co., Ltd., Shanghai (CN)

(72) Inventors: Jianxiong (Jesse) Li, Shanghai (CN); Reicky Zhang, Shanghai (CN); Neil Shi, Shanghai (CN); Lei Li, Suzhou (CN); Tomo Hu, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 19/083,563

(22) Filed: Mar. 19, 2025

(30) Foreign Application Priority Data
Mar. 19, 2024 (CN) 202410316154.5

(51) Int. Cl. H01R 13/6581

(52) U.S. Cl. CPC H01R 13/6581

(57) ABSTRACT

A shielding component includes a cylindrical body having a front end and a rear end opposite the front end in an axial direction, and a plurality of cantilevers connected to the front end of the cylindrical body and insertable into a mounting hole in a mounting panel. Each of the cantilevers has a spring arm part electrically contacting an inner wall surface of the mounting hole, a fixing part connected between the spring arm part and the cylindrical body, and a rigid protrusion protruding outward on the fixing part. The rigid protrusion is interference fit with the inner wall surface of the mounting hole. An inner side of the fixing part rests against a terminal holder of a connector to limit a radial movement of the shielding component relative to the mounting panel in a radial direction of the mounting hole.

### CROSS-REFERENCE TO RELATED APPLICATION

This application claims the benefit of the filing date under 35 U.S.C. § 119(a)-(d) of Chinese Patent Application No. 202410316154.5, filed on Mar. 19, 2024.

### FIELD OF THE INVENTION

The present invention relates to a shielding component for a connector and a connector comprising the shielding component.

### BACKGROUND OF THE INVENTION

A shielding component is usually installed on a terminal holder of a connector. One end of the shielding component is used to mate with a mating shielding component of a mating connector, and the other end is formed with multiple cantilevers for insertion into a mounting hole in a mounting panel and electrical contact with the inner wall surface of the mounting hole.

In order to prevent the shielding component from radially shaking relative to the mounting panel, the shielding component also requires a support layer for interference fit with the inner wall surface of the mounting hole. Therefore, the existing shielding component usually has a two-layer structure, with the outer layer used for fixed support and the inner layer used for elastic contact. This two-layer structure has the disadvantages of complexity, difficult manufacturing, and high cost. However, if the shielding component is not provided with the support layer, it will experience significant radial shaking relative to the mounting panel during vibration, which can lead to severe wear of the shielding component, high contact resistance, and unstable electrical contact.

### SUMMARY OF THE INVENTION

A shielding component includes a cylindrical body having a front end and a rear end opposite the front end in an axial direction, and a plurality of cantilevers connected to the front end of the cylindrical body and insertable into a mounting hole in a mounting panel. Each of the cantilevers has a spring arm part electrically contacting an inner wall surface of the mounting hole, a fixing part connected between the spring arm part and the cylindrical body, and a rigid protrusion protruding outward on the fixing part. The rigid protrusion is interference fit with the inner wall surface of the mounting hole. An inner side of the fixing part rests against a terminal holder of a connector to limit a radial movement of the shielding component relative to the mounting panel in a radial direction of the mounting hole.

### BRIEF DESCRIPTION OF THE DRAWINGS

The invention will now be described by way of example with reference to the accompanying figures, of which:

FIG. 1 shows a perspective view of a connector according to an exemplary embodiment of the present invention;

FIG. 2 shows a sectional perspective view of a connector according to an exemplary embodiment of the present invention;

FIG. 3 shows an exploded sectional view of a connector according to an exemplary embodiment of the present invention;

FIG. 4 shows a perspective view of a shield of a connector according to an exemplary embodiment of the present invention;

FIG. 5 shows a sectional perspective view of a shielding component of a connector according to an exemplary embodiment of the present invention;

FIG. 6 shows a perspective view of a connector and mounting panel according to an exemplary embodiment of the present invention;

FIG. 7 shows a sectional perspective view of the shielding component of a connector inserted into the mounting hole in the mounting panel according to an exemplary embodiment of the present invention; and

FIG. 8 shows an enlarged sectional perspective view of a connector and mounting panel according to an exemplary embodiment of the present invention, in which the cantilever of the shielding component is shown.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

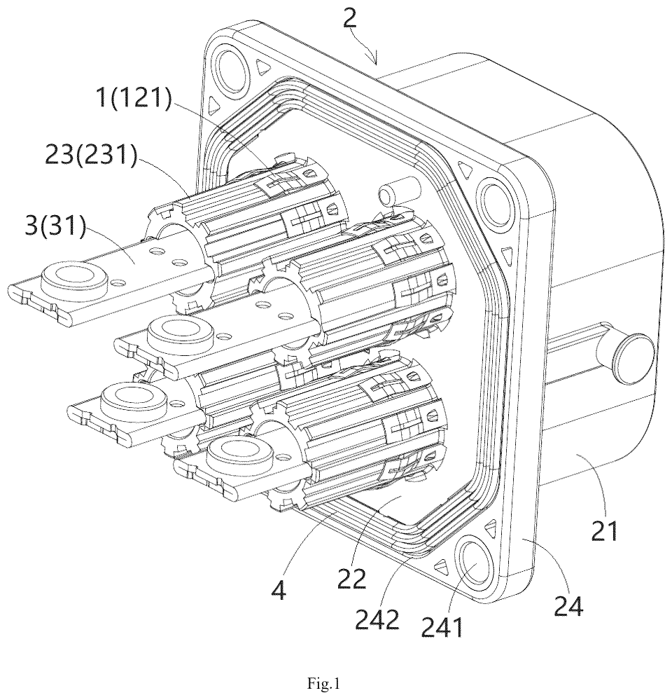

As shown in FIGS. 1 to 8, in an exemplary embodiment of the present invention, a shielding component 1 is disclosed, which is used for fitting onto a terminal holder 23 of a connector. The shielding component 1 includes a cylindrical body 11 and a plurality of cantilevers 12. The cylindrical body 11 has front and rear ends that are opposite in its axial direction. The cantilevers 12 are connected to the front end of the cylindrical body 11 and are suitable for insertion into a mounting hole 501 in a mounting panel 5.

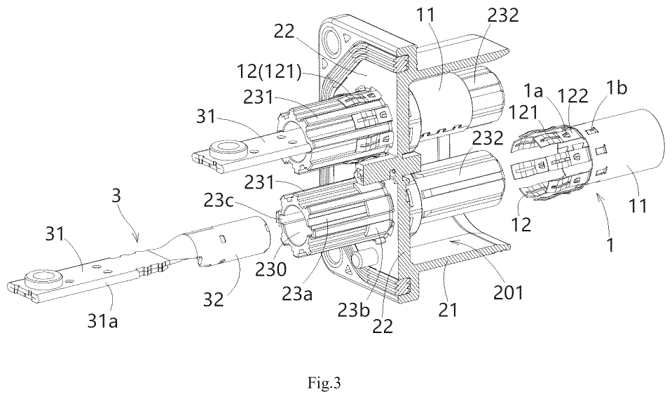

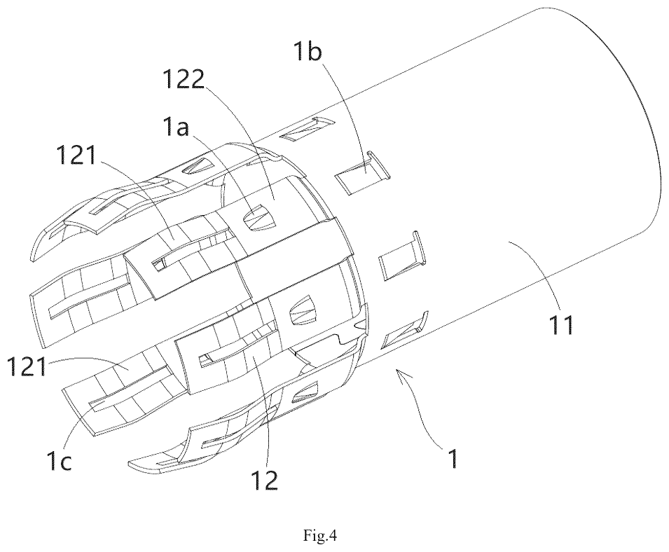

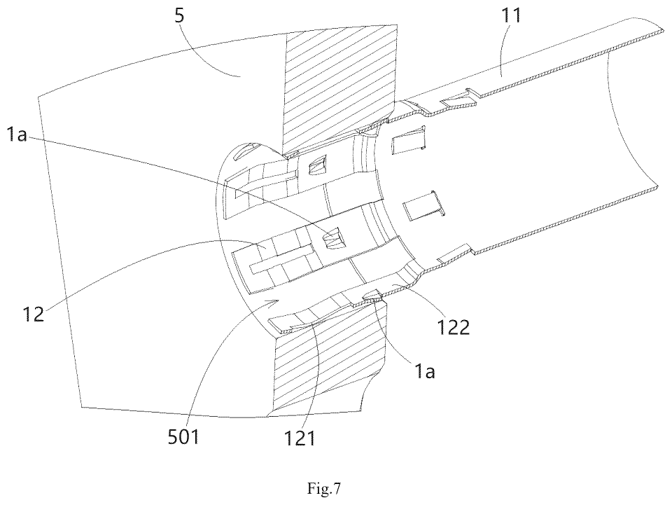

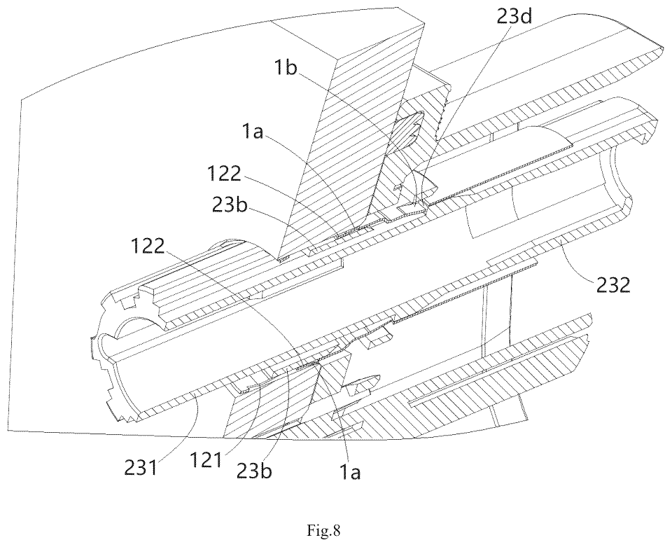

As shown in FIGS. 3 and 4, in the illustrated embodiment, each of the cantilevers 12 includes a spring arm part 121 and a fixing part 122. The spring arm part 121 is used to make electrical contact with the inner wall surface of the mounting hole 501. The fixing part 122 is connected between the spring arm part 121 and the cylindrical body 11, and a rigid protrusion 1a protruding outward is formed on the fixing part 122. The rigid protrusion 1a can be interference fit with the inner wall surface of the mounting hole 501, as shown in FIG. 7, and the inner side of the fixing part 122 is suitable for resting against the terminal holder 23, as shown in FIG. 8, to limit the radial shaking of the shielding component 1 relative to the mounting panel 5 in the radial direction of the mounting hole 501. Therefore, even in a vibrating environment, there will be no significant shaking of the shielding component 1 relative to the mounting panel 5, which reduced the degree of wear of the shielding component 1 and can reliably ensure stable electrical contact between the shielding component 1 and the mounting panel 5. In addition, the shielding component 1 has a simple structure, is easy to manufacture, and greatly reduces manufacturing costs.

In the illustrated embodiment, multiple cantilevers 12 are uniformly spaced and distributed in the circumferential direction of the cylindrical body 11, and extend a predetermined length forward from the front end of the cylindrical body 11.

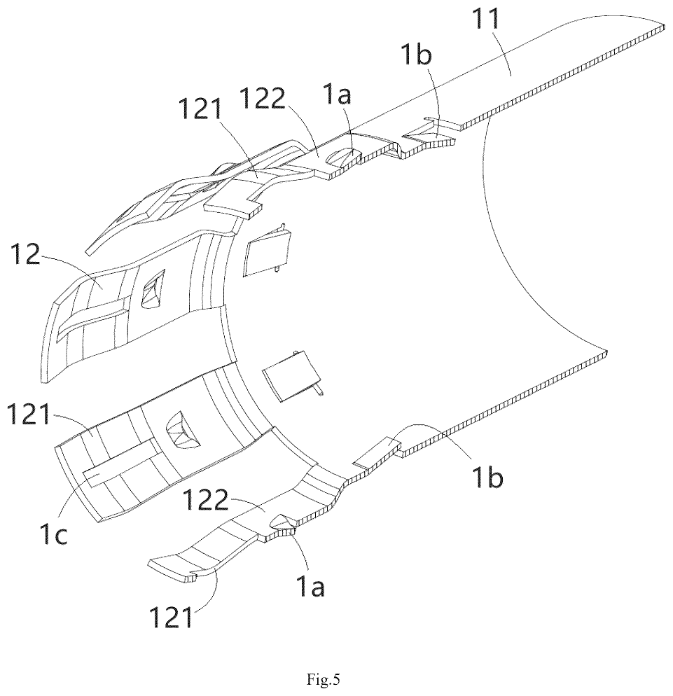

As shown in FIGS. 4 and 5, in the illustrated embodiment, the spring arm part 121 is arched outward to make electrical contact with the inner wall surface of the mounting hole 501 of the mounting panel 5. In the illustrated embodiment, the rigid protrusion 1a is a convex hull protruding outward from the outer side of the fixing part 122, which is located in the middle of the width direction of the fixing part 122. However, the present invention is not limited to the illustrated embodiment. For example, in another exemplary embodiment of the present invention, the rigid protrusion 1a may be a convex rib protruding outward from the fixing part 122, which extends along the width direction of the fixing part 122.

As shown in FIGS. 4 and 5, in the illustrated embodiment, a slot hole 1c is formed in the spring arm part 121, and the slot hole 1c extends along the length direction of the spring arm part 121 to increase its elasticity. However, the present invention is not limited to the illustrated embodiment. For example, in another exemplary embodiment of the present invention, multiple through holes may be formed in the spring arm part 121, and the multiple through holes may be arranged in a row along the length direction of the spring arm part 121 to increase its elasticity.

As shown in FIGS. 4 and 5, in the illustrated embodiment, multiple locking spring pieces 1b are formed on the cylindrical body 11. These locking spring pieces 1b are evenly spaced and distributed in the circumferential direction of the cylindrical body 11, and are close to the front end of the cylindrical body 11. They are used to engage with the terminal holder 23 to lock the shielding component 1 onto the terminal holder 23.

As shown in FIG. 8, in the illustrated embodiment, the locking spring piece 1b extends obliquely towards the interior of the cylindrical body 11 and is adapted to rest against the step portion 23d of the terminal holder 23 along the axial direction of the cylindrical body 11, to prevent the shielding component 1 fitted on the terminal holder 23 from being pulled out of the terminal holder 23.

In the illustrated embodiment, the rear end of the cylindrical body 11 is suitable for mating with a mating shielding component of a mating connector to make electrical contact with the mating shielding component.

In the illustrated embodiment, the shielding component 1 is an integral stamped part.

In another exemplary embodiment of the present invention, a connector is also disclosed. The connector, as shown in FIGS. 1 to 3, includes a housing 2 and the aforementioned shielding component 1. The housing 2 includes a peripheral wall 21 and a bottom wall 22 for enclosing an inner cavity 201, as well as a terminal holder 23 for installing a terminal 3. The shielding component 1 is fitted onto the terminal holder 23.

When the housing 2 is installed on the mounting panel 5, as shown in FIGS. 7 and 8, the multiple cantilevers 12 of the shielding component 1 are inserted into the mounting hole 501 in the mounting panel 5. The rigid protrusions 1a on the fixing parts 122 of the cantilevers 12 are in interference fit with the inner wall surface of the mounting hole 501, and the inner side of the fixing parts 122 of the cantilevers 12 are pressed against the terminal holder 23 to limit the radial shaking of the shielding component 1 relative to the mounting panel 5 in radial direction of the mounting hole 501.

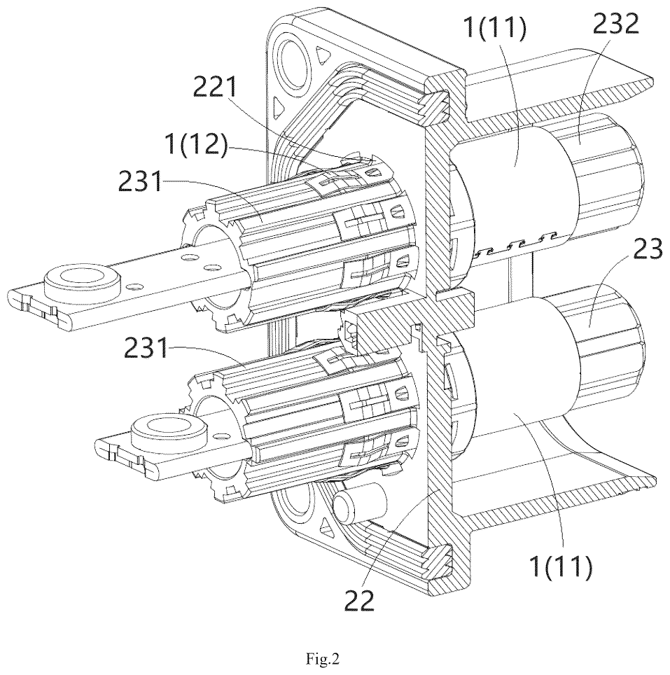

As shown in FIG. 3, in the illustrated embodiment, the terminal holder 23 includes an inner retaining body 232 and an outer retaining body 231. The inner retaining body 232 is located inside the inner cavity 201 and connected to the inner side of the bottom wall 22. The outer retaining body 231 is located outside the inner cavity 201 and connected to the outer side of the bottom wall 22. The cylindrical body 11 of the shielding component 1 is fitted onto the inner retaining body 232, and a plurality of insertion holes 221, shown in FIG. 2, are formed in the bottom wall 22 to allow the multiple cantilevers 12 of the shielding component 1 to pass through. The multiple cantilevers 12 respectively pass through the multiple insertion holes 221 and wrap around the outer retaining body 231.

As shown in FIG. 8, in the illustrated embodiment, when the housing 2 is installed on the mounting panel 5, the outer retaining body 231 passes through the mounting hole 501 in the mounting panel 5, and the cantilevers 12 of the shielding component 1 are inserted into the mounting hole 501 and electrically contact the inner wall surface of the mounting hole 501.

As shown in FIG. 3, in the illustrated embodiment, multiple axial grooves 23a corresponding to the multiple spring arm parts 121 of the shielding component 1 are formed on the outer retaining body 231, and the spring arm parts 121 are respectively suspended in the multiple axial grooves 23a to position the spring arm parts 121 in the circumferential direction and allow clastic deformation of the spring arm parts 121 in the radial direction.

As shown in FIG. 8, in the illustrated embodiment, multiple support parts 23b corresponding to the multiple fixing parts 122 of the shielding component I are formed on the outer holding body 231, and the multiple support parts 23b are respectively pressed against the inner sides of the multiple fixing parts 122 to prevent the fixing parts 122 from being moved radially.

As shown in FIG. 8, in the illustrated embodiment, multiple step portions 23d corresponding to the multiple locking spring pieces 1b of the shielding component 1 are formed on the inner retaining body 232, and the multiple step portions 23d are axially pressed against the ends of the multiple locking spring pieces 1b to prevent the shielding component 1 from being pulled out of the end retaining body 23.

As shown in FIG. 1, in the illustrated embodiment, the housing 2 further includes a flange portion 24 connected to the bottom of the peripheral wall 21, and a connection hole 241 is formed in the flange portion 24 to allow a threaded connection member to pass through, so that the flange portion 24 can be fastened to the mounting panel 5 through the threaded connection member passing through the connection hole 241.

As shown in FIG. 1, in the illustrated embodiment, a sealing ring installation groove 242 is formed on the bottom surface of the flange portion 24. The connector also includes a scaling ring 4, which is installed into the sealing ring installation groove 242. The sealing ring 4 is suitable for being compressed between the flange portion 24 and the mounting panel 5 to achieve scaling between the housing 2 and the mounting panel 5.

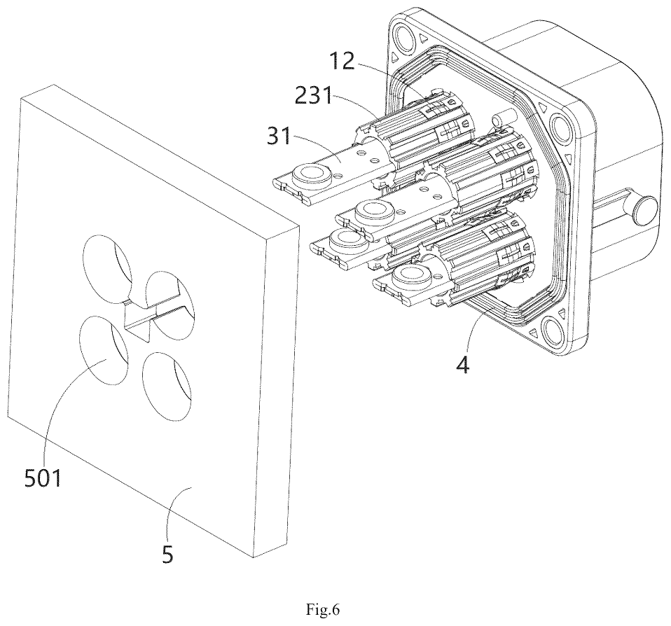

As shown in FIG. 6, in the illustrated embodiment, the connector includes multiple shielding components 1 for respectively inserting into multiple mounting holes 501 in the mounting panel 5, and the housing 2 includes multiple terminal holders 23, with multiple shielding components 1 respectively fitted onto the multiple terminal holders 23.

As shown in FIG. 1, in the illustrated embodiment, the terminal holder 23 is cylindrical and connected to the bottom wall 22. A terminal insertion hole 230 for inserting the terminal 3 is formed in the terminal holder 23, as shown in FIG. 3, and the terminal insertion hole 230 penetrates axially through the terminal holder 23 and the bottom wall 22.

As shown in FIGS. 1 to 3, in the illustrated embodiment, the connector further includes a terminal 3, which is inserted into the terminal insertion hole 230 of the terminal holder 23. The terminal 3 includes a cylindrical mating portion 32 located within the inner retaining body 232 for mating with a mating terminal 3 of a mating connector inserted into the inner retaining body 232.

As shown in FIG. 3, in the illustrated embodiment, the terminal 3 further includes a flat connecting portion 31 axially opposite to the mating portion 32. The connecting portion 31 is located in the outer retaining body 231 and extends from the outer retaining body 231 for electrical connection with a connecting terminal inside a device.

As shown in FIGS. 1 to 3, in the illustrated embodiment, the cross-section of the terminal insertion hole 230 is circular, and a pair of axially extending positioning grooves 23c are formed in the outer retaining body 231. The two longitudinal edge portions 31a of the flat connecting portion 31 of terminal 3 are respectively positioned in the pair of positioning grooves 23c.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A shielding component, comprising:
a cylindrical body having a front end and a rear end opposite the front end in an axial direction; and
a plurality of cantilevers connected to the front end of the cylindrical body and insertable into a mounting hole in a mounting panel, each of the cantilevers has a spring arm part electrically contacting an inner wall surface of the mounting hole, a fixing part connected between the spring arm part and the cylindrical body, and a rigid protrusion protruding outward on the fixing part, the rigid protrusion is interference fit with the inner wall surface of the mounting hole, an inner side of the fixing part rests against a terminal holder of a connector to limit a radial movement of the shielding component relative to the mounting panel in a radial direction of the mounting hole.

2. The shielding component according to claim 1, wherein the cantilevers are evenly spaced in a circumferential direction of the cylindrical body and extend forward from the front end of the cylindrical body.

3. The shielding component according to claim 1, wherein the spring arm part is arched outward to make electrical contact with the inner wall surface of the mounting hole.

4. The shielding component according to claim 1, wherein:
the rigid protrusion is a convex hull protruding from an outer side of the fixing part, and the convex hull is located in a middle of a width direction of the fixing part; or
the rigid protrusion is a convex rib protruding from the outer side of the fixing part, and the convex rib extends along the width direction of the fixing part.

5. The shielding component according to claim 1, wherein:
a slot hole is formed in the spring arm part, the slot hole extends along a length direction of the spring arm part and increases an elasticity of the spring arm part; or
a plurality of through holes are formed in the spring arm part, the through holes are arranged in a row along the length direction of the spring arm part and increase the elasticity of the spring arm part.

6. The shielding component according to claim 1, wherein a plurality of locking spring pieces are formed on the cylindrical body, the locking spring pieces are evenly spaced in a circumferential direction of the cylindrical body and adjacent to the front end of the cylindrical body, the locking spring pieces engage with the terminal holder to lock the shielding component onto the terminal holder.

7. The shielding component according to claim 6, wherein the locking spring pieces extend obliquely towards an interior of the cylindrical body and rest on a step portion of the terminal holder along the axial direction to prevent the shielding component fitted on the terminal holder from being pulled out of the terminal holder.

8. The shielding component according to claim 1, wherein the rear end of the cylindrical body is matable with a mating shielding component of a mating connector to make electrical contact with the mating shielding component.

9. The shielding component according to claim 1, wherein the shielding component is an integral stamped part.

10. A connector, comprising:
a housing including a peripheral wall and a bottom wall enclosing an inner cavity, and a terminal holder receiving a terminal; and
a shielding component fitted onto the terminal holder, the shielding component includes a cylindrical body having a front end and a rear end opposite the front end in an axial direction, and a plurality of cantilevers connected to the front end of the cylindrical body, when the housing is installed on a mounting panel, the cantilevers of the shielding component are inserted into a mounting hole in the mounting panel, each of the cantilevers has a spring arm part electrically contacting an inner wall surface of the mounting hole, a fixing part connected between the spring arm part and the cylindrical body, and a rigid protrusion protruding outward on the fixing part, the rigid protrusion is interference fit with the inner wall surface of the mounting hole, an inner side of the fixing part is pressed against the terminal holder to limit a radial movement of the shielding component relative to the mounting panel in a radial direction of the mounting hole.

11. The connector according to claim 10, wherein the terminal holder includes:
an inner retaining body located inside the inner cavity and connected to an inner side of the bottom wall; and
an outer retaining body located outside the inner cavity and connected to an outer side of the bottom wall, the cylindrical body of the shielding component is fitted onto the inner retaining body, a plurality of insertion holes are formed in the bottom wall, the cantilevers respectively pass through the insertion holes and surround the outer retaining body, the outer retaining body passes through the mounting hole in the mounting panel when the housing is installed onto the mounting panel.

12. The connector according to claim 11, wherein a plurality of axial grooves corresponding to the spring arm parts of the shielding component are formed on the outer retaining body, the spring arm parts are respectively suspended in the axial grooves to position the spring arm parts in a circumferential direction and allow the spring arm parts to elastically deform in the radial direction.

13. The connector according to claim 11, wherein a plurality of support parts corresponding to the fixing parts of the shielding component are formed on the outer retaining body, the support parts are respectively pressed against a plurality of inner sides of the fixing parts to prevent the fixing parts from being moved in the radial direction.

14. The connector according to claim 11, wherein a plurality of step portions corresponding to a plurality of locking spring pieces of the cylindrical body are formed on the inner retaining body, the step portions are axially pressed against a plurality of ends of the locking spring pieces to prevent the shielding component from being pulled out of the terminal holder.

15. The connector according to claim 10, wherein the housing includes a flange portion connected to a bottom of the peripheral wall and a connection hole formed in the flange portion that receives a threaded connection member, the flange portion is fastenable to the mounting panel by the threaded connection member passing through the connection hole.

16. The connector according to claim 15, wherein a sealing ring installation groove is formed on a bottom surface of the flange portion, the connector further comprises a sealing ring installed in the sealing ring installation groove, the sealing ring is compressed between the flange portion and the mounting panel to seal between the housing and the mounting panel.

17. The connector according to claim 11, wherein the shielding component is one of a plurality of shielding components respectively inserted into a plurality of mounting holes in the mounting panel, the terminal holder is one of a plurality of terminal holders of the housing, the shielding components are each fitted onto one of the terminal holders.

18. The connector according to claim 11, wherein the terminal holder is cylindrical and connected to the bottom wall, a terminal insertion hole receiving the terminal is formed in the terminal holder, the terminal insertion hole axially penetrates through the terminal holder and the bottom wall.

19. The connector according to claim 18, wherein the terminal has a cylindrical mating portion in the inner retaining body for mating with a mating terminal of a mating connector inserted into the inner retaining body.

20. The connector according to claim 19, wherein the terminal has a flat connecting portion axially opposite to the cylindrical mating portion, the flat connecting portion is located in the outer retaining body and extends from the outer retaining body.

21. The connector according to claim 20, wherein a cross-section of the terminal insertion hole is circular, and a pair of axially extending positioning grooves are formed in the outer retaining body, a pair of longitudinal edge portions of the flat connecting portion of the terminal are respectively positioned in the pair of axially extending positioning grooves.
